(19) United States
(12) Patent Application Publication
(10) Pub. No.: US 2020/0207331 A1
(43) Pub. Date: Jul. 2, 2020

(54) DRIVING ASSISTANCE APPARATUS AND METHOD

(71) Applicant: Korea Aerospace Research Institute, Daejeon (KR)

(72) Inventors: Byeong Hee CHANG, Daejeon (KR); Young Min PARK, Daejeon (KR); Chang Ho LEE, Daejeon (KR); Yung Gyo LEE, Daejeon (KR)

(73) Assignee: Korea Aerospace Research Institute, Daejeon (KR)

(21) Appl. No.: 16/643,563

(22) PCT Filed: Jul. 24, 2018
(86) PCT No.: PCT/KR2018/008313

§ 371 Date: Mar. 1, 2020

(30) Foreign Application Priority Data
Sep. 5, 2017 (KR) 10-2017-0113091

(51) Int. Cl. B60W 30/02; B60W 40/105; B60W 50/14; G01P 5/24; G01P 13/02

(52) U.S. Cl. CPC B60W 30/02; B60W 40/105; B60W 50/14; G01P 5/24; B60W 2555/20; B60W 2050/146; B60W 2050/143; B60W 2422/00; G01P 13/02

(57) ABSTRACT

The present invention relates to a driving assistance apparatus for a vehicle, and comprises: a wind sensor, which assigns in advance, through wind tunnel tests and the like, a driving stability region in which driving stability of the vehicle is maintained, and is attached to one side of the vehicle so as to measure two-dimensional wind direction and wind speed; and a processor for determining driving stability by using the driving speed of the vehicle and information of the wind direction and the wind speed which are measured by the wind sensor.

### TECHNICAL FIELD

Example embodiments relate to an apparatus and method for assisting a vehicle to travel, and more particularly, to an apparatus and method for providing a method for enhancing driving stability of a terrestrial driving vehicle using an anemometer.

### BACKGROUND ART

An aerodynamic force acting on the airplane is determined by a relative speed with the wind rather than an absolute speed of the airplane. The relative speed is obtained by measuring total pressure and static pressure around the airplane. Because the airplane becomes structurally dangerous when the relative speed of the airplane is too high and because the airplane is to crash in stall when the relative speed is too low, as a result, the airplane flies within the flight envelope which is set to a relative speed region flyable for each altitude.

The principle where the aerodynamic force acting on a terrestrial driving vehicle is the same as that in the airplane. However, only an absolute speed using the number of revolutions of the wheels is measured and a relative wind speed is not measured, whereas the influence of the relative speed is reflected in driving in a manner which decelerates when the driver feels a strong wind. Recently, research in the autonomous driving vehicles has been actively conducted, a driving assistance apparatus for reflecting the influence of wind is necessary to ensure driving stability in case of an unmanned car or a passenger car without a driver.

### DETAILED DESCRIPTION OF THE INVENTION

### Solutions

Similar to the flight envelope of the airplane, a driving stability region where it is possible for the vehicle to stably travel may be set. The driving stability region of the vehicle may be evaluated and set in advance according to the relative wind speed and direction formed by the vehicle speed and the wind. In other words, when the relative wind is provided to the vehicle using test facilities such as wind tunnels and when the influence of an aerodynamic force acting on the vehicle on the stability of the vehicle is evaluated, the driving stability region may be determined by a limited relative wind speed for each relative wind direction.

The driving stability region may not be determined by only a vehicle configuration and may be varied according to a weight of the vehicle, a location of center of gravity, or the like. Thus, the driving stability region may be set differently according to a type of vehicle. Illustratively, the driving stability region may be set widely for a sports car with lower height and may be set narrowly for a box car or a truck with higher height.

While the vehicle is traveling, a current relative speed of the vehicle is compared with the predetermined driving stability region to determine driving stability. In other words, when the relative speed of the vehicle gets out of the predetermined driving stability region, it is determined that it is unstable. When the relative speed of the vehicle is within the predetermined driving stability region, it is determined that it is stable.

According to an aspect, there is provided a driving assistance apparatus including a wind sensor that is attached to one side of the vehicle and measures a relative wind direction & speed and a processor that compares a relative wind speed with respect to the predetermined driving stability region using a driving speed of the vehicle and information about the wind direction and the wind speed, which are measured by the wind sensor, to determine driving stability.

According to another embodiment, the apparatus may further include a display unit that displays the driving stability region and the driving stability or a notification unit that provides a notification of a warning message when the relative speed of the vehicle gets out of the predetermined driving stability region.

According to another embodiment, the wind sensor may be attached to a bonnet or a roof of the vehicle.

According to an embodiment, the apparatus may further include a controller that decelerates the vehicle speed or separately controls a direction and a rotational speed of each wheel when the relative speed of the vehicle gets out of the predetermined driving stability region. The wind sensor may be a general wind anemometer such as a multi-hole pressure probe, an ultrasonic wind anemometer, a laser Doppler velocimetry (LDV), a particle image velocimetry (PIV), or a how-wire anemometer. It is sufficient that the wind sensor is a two-dimensional wind anemometer that measures a relative wind direction and speed in a horizontal plane, but not limited thereto.

According to another aspect, there is provided a driving assistance method for a vehicle, which is at least temporarily implemented by a computer, including measuring, by a wind sensor attached to one side of the vehicle, a two-dimensional wind direction and wind speed; calculating, by a processor, a relative wind speed using a driving speed of the vehicle and information about the wind direction and wind speed measured by the wind sensor, and comparing the relative wind speed and direction with a predetermined driving stability region to determine driving stability.

According to another aspect, the method may further include displaying, by a display unit, the driving stability region and the driving stability or providing, by a notification unit, a notification of a warning message, when the relative speed of the vehicle gets out of the predetermined driving stability region.

According to another aspect, the wind sensor is attached to a bonnet or a roof of the vehicle to measure the two-dimensional wind direction and wind speed.

According to another aspect, the method may further include decelerating, by a controller, the vehicle or separately controlling, by the controller, a direction and a rotational speed of each wheel, when the relative speed of the vehicle gets out of the predetermined driving stability region. Furthermore, the wind sensor may measure a two-dimensional wind direction and wind speed using an ultrasonic wave.

According to another aspect, there is provided a computer-readable storage medium storing a program for performing the driving assistance method.

According to another aspect, there is provided a vehicle including a driving assistance apparatus for the vehicle including a wind sensor that is attached to one side of the vehicle and measures a wind speed and direction and a processor that compares a relative wind speed with a predetermined driving stability region using a driving speed of the vehicle and information about the wind direction and the wind speed, which are measured by the wind sensor, to determine driving stability.

### BRIEF DESCRIPTION OF DRAWINGS

FIG. 1 illustrates a two-dimensional pressure-type wind sensor according to an embodiment;

FIG. 2 is a flowchart for determining driving stability according to an embodiment;

FIG. 3 illustrates a two-dimensional ultrasonic wind sensor according to an embodiment;

FIG. 4 illustrates the appearance of a vehicle equipped with a two-dimensional wind sensor according to an embodiment;

FIG. 5 illustrates a driving stability region according to an embodiment;

FIG. 6 illustrates a region with high driving stability according to an embodiment; and

FIG. 7 illustrates a region with low driving stability according to an embodiment.

### BEST MODE FOR CARRYING OUT THE INVENTION

Hereinafter, embodiments will be described in detail with reference to the accompanying drawings. However, the scope of the patent application is not restricted or limited by these embodiments. The same reference numerals shown in each drawing represent the same members.

Terms most generally and widely used in a related technical field are used herein. However, other terms may be selected based on development and/or change of related technologies, practices, preferences by one of ordinary skill in the art, and the like. Thus, the terminology used herein is for the purpose of describing particular embodiments only and is not intended to limit technical features.

In addition, terms selected by an applicant(s) may also be used herein, and the meanings of such terms are described in the Detailed Description section. The terms used herein are not to be interpreted based solely on the terms themselves, but to be interpreted based on the meanings of the terms as defined herein and the overall context of the present disclosure.

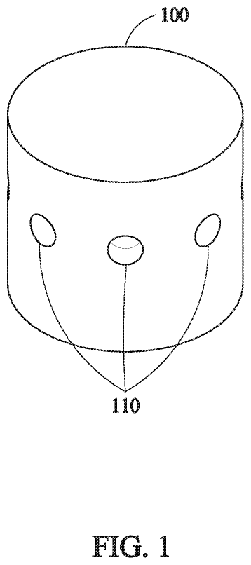

FIG. 1 illustrates a two-dimensional pressure-type wind sensor according to an embodiment.

A two-dimensional pressure-type wind sensor 100 shown in FIG. 1 is merely illustrative, but not limit thereto. The wind sensor 100 may be equipped with a plurality of pressure holes in an outer circumference of a cylinder and may measure pressure of air introduced into the pressure holes 110. The plurality of pressure holes 110 may illustratively be 8 pressure holes 110, but not limited thereto. Pressures of air introduced in various directions on two dimensions may be compared to calculate a wind direction and a wind speed of a point where the wind sensor 100 is installed.

As influence according to a shape of a vehicle is included in a relative wind at the point where the wind sensor 100 is installed, because there may be a difference between a driving speed of the vehicle and a relative speed with the wind on the air, correction is needed. A correction formula therefor may be obtained in advance through wind tunnel tests of the vehicle in which the wind sensor 100 is installed. This wind tunnel tests may be included in wind tunnel tests for setting a driving stability region of the vehicle. A relative speed measured by the wind sensor 100 of the vehicle which is traveling may be corrected using the correction formula.

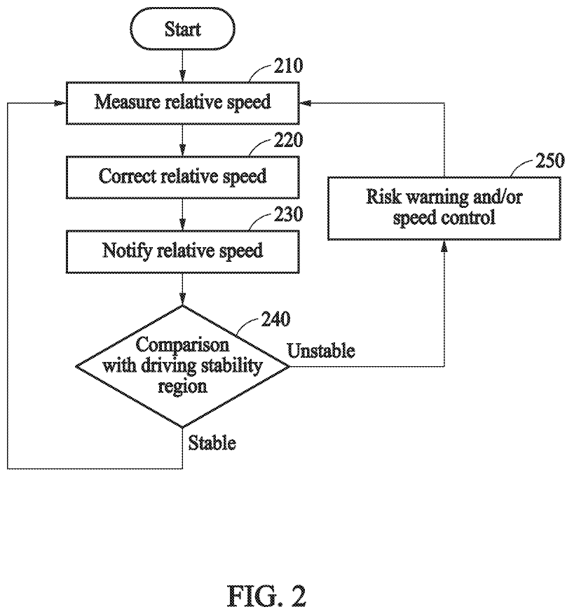

FIG. 2 is a flowchart for determining driving stability according to an embodiment.

According to an embodiment, a method for determining driving stability at a processor may be to measure a relative speed (210), correct the relative speed using a predetermined correction formula (220), and notify a driver of the relative speed (230). The processor may be to perform comparison with a predetermined driving stability region. Finally, the processor may be to determine driving stability and return to the step 210 of measuring a relative speed again without special processing when it is stable to continue performing monitoring. On the other hand, when it is determined that it is unstable, the processor may be to warn the driver of the risk and/or perform speed control (250) and may return to the step 210 of measuring a relative speed again.

A description will be given in detail for each step. For determining driving stability starts, a relative speed may first be measured (210). The relative speed refers to a relative speed between a vehicle and the wind with regard to a driving speed of the vehicle and the wind speed which is measured by a wind sensor.

The processor may correct the relative speed measured by the wind sensor, using a predetermined correction formula (220).

The step 230 of notifying the driver of the relative speed may be performed when a display unit is further included according to an embodiment. The display unit may provide information about a current relative speed of the vehicle. This is merely illustrative and is not necessarily limited to notifying the driver of only the relative speed. It is possible to provide information about measured wind direction and speed information or the like together with a driving speed of the vehicle.

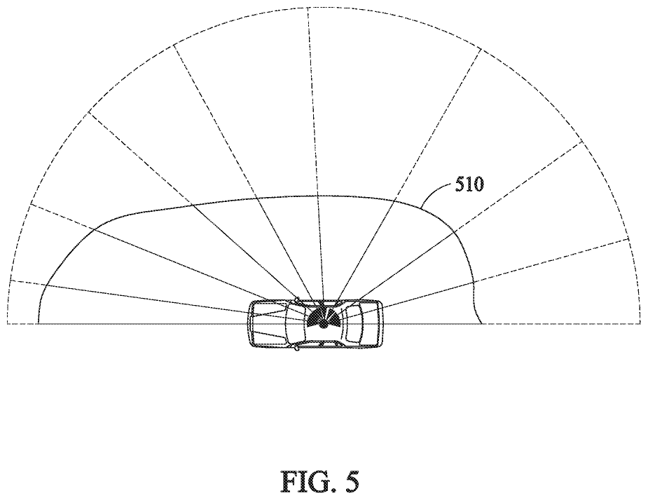

The information about the relative speed of the vehicle may be illustratively provided in the form of images shown in FIGS. 5 to 7. It is possible for the information about the relative speed of the vehicle to be simply displayed in units of velocity such as m/s or km/h.

The step 240 of performing the comparison with the driving stability region may be the step of comparing the predetermined driving stability region with a region according to a current relative speed. The driving stability region refers to a relative speed region where the vehicle is able to travel stably. The driving stability region determined as being stable through wind tunnel tests of the vehicle may be preset, and information of the preset driving stability region may be stored. The stored information about the predetermined driving stability region may be compared with a current relative speed of the vehicle to determine driving stability. When the relative speed of the vehicle gets out of the driving stability region, it may be determined that it is unstable. When the current relative speed is within the driving stability region, it may be determined that it is stable.

In some cases, because there is no problem especially when it is stable, the processor may be to return to the step 210 of measuring a relative speed to continue monitoring the relative speed and determine stability.

On the other hand, when it is unstable, the processor may be to warn the driver of the risk and/or perform speed control (250). The risk warning may be provided when a notification unit is further included according to an embodiment. A visual notification through the display unit and an audible notification through a warning sound are possible in the notification method.

Illustratively, a visual notification in which the display unit is turned on/off or turns red is possible. Furthermore, according to another embodiment, a method for displaying a warning message such as “dangerous wind speed” on the display unit is possible. Alternatively, a tactile notification of making a seat or a steering wheel vibrate is possible.

According to an embodiment, when it is determined that it is unstable, it is possible for a controller to automatically control a speed of the vehicle. When a driver rides in the vehicle, the driver may directly perform speed control, but the controller may automatically perform speed control for driving assistance. Particularly, for an autonomous vehicle, speed control may be performed.

Because a relative speed gets out of the driving stability region as the relative speed is higher, the vehicle may be illustratively controlled to decelerate to reduce the relatively speed.

When the vehicle decelerates within a current relative speed due to the deceleration, the processor may be to stop decelerating and may start the step of measuring a relative speed again.

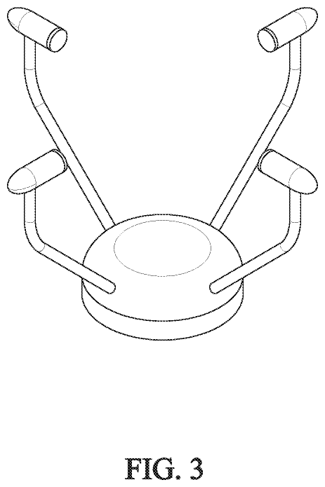

FIG. 3 illustrates a two-dimensional ultrasonic wind sensor according to an embodiment.

A two-dimensional ultrasonic wind sensor shown in FIG. 3 may be illustratively an ultrasonic anemometer. The two-dimensional wind sensor may be designed to have a low height such that a portion for measuring the wind is as close as possible to the surface of a vehicle.

In detail, the wind sensor may fail to include a separate mast such that a surface attached to the vehicle and the portion for measuring the wind are close to each other.

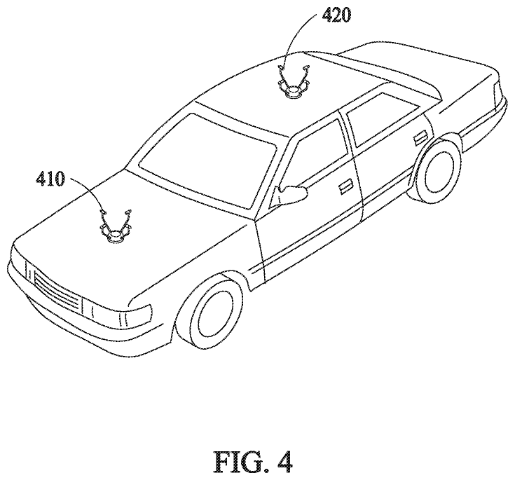

FIG. 4 illustrates the appearance of a vehicle equipped with a two-dimensional wind sensor according to an embodiment.

Wind sensors 410 and 420 are illustrative, but not limited thereto, which may be installed on a bonnet or a roof of a vehicle. It is advantageous for the wind sensor 410 installed on the bonnet of the vehicle to measure the wind acting on a front portion of the vehicle, whereas it is advantageous for the wind sensor 420 installed on the roof of the vehicle to measure the wind blowing in all directions.

According to an embodiment, there may be only one of the wind sensors 410 and 420, and there may be a plurality of wind sensors attached to different sides of the vehicles. A position attachable to the vehicle may be a trunk, a side mirror, or the like.

The wind sensors 410 and 420 in FIG. 4 are shown as ultrasonic wind sensors, but, as described above, may be different wind anemometers, such as a multi-hole pressure probe, a laser Doppler velocimetry (LDV), a particle image velocimetry (PIV), and a how-wire anemometer. It may be sufficient that the wind sensor 410 and 420 are two-dimensional wind anemometers, each of which measures a wind direction and a wind speed in a horizontal plane, but not limited thereto.

Each of driving stability regions shown in FIGS. 5 to 7 is shown as only a right half of the vehicle. Because the general vehicle is bilaterally symmetrical in shape, only one side is shown and a left half region of the vehicle may be configured to be symmetrical with a region displayed on a right half. This is merely illustrative, and, when the vehicle is not bilaterally symmetrical in shape, for example, for a sidecar, the driving stability region may be configured not to be bilaterally symmetrical.

FIG. 5 illustrates a driving stability region according to an embodiment.

FIG. 5 illustrates a predetermined limit of a relative speed, in which driving stability for each wind direction is maintained, using bold arrows and illustrates a driving stability region 510 using a curved line connecting them. The driving stability region 510 may be a relative speed region where it is possible to perform stably driving, which is information stored in advance in the vehicle through wind tunnel tests.

The driving stability region 510 may be set differently according to a type of vehicle. Illustratively, the driving stability region 510 may be set widely for a sports car with a low vehicle height and may be set narrowly for a box car or a truck with a high vehicle height. The driving stability region 510 may only be determined by a form of the vehicle and may be varied according to a weight of the vehicle, a location of center of gravity, or the like.

On the general design of the vehicle, the driving stability region 510 according to an embodiment may be displayed widely when the wind blows from the front and may be displayed relatively narrowly when the wind blows from the side and rear. This is merely illustrative, but not limited thereto, and as described above, this may be varied according to a shape of the vehicle, or the like.

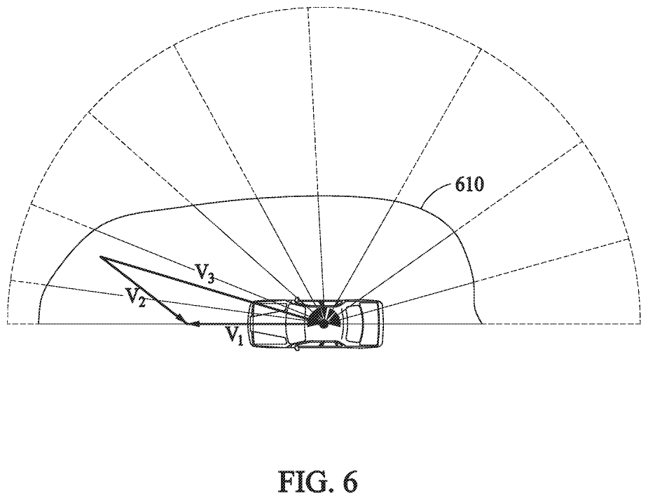

FIG. 6 illustrates a region with high driving stability according to an embodiment.

Because a current relative velocity V3 is within a predetermined driving stability region 610, driving stability may be high. In other words, it is stable.

Illustratively, there is little wind except for an influence by driving of the vehicle, or the driving speed itself the vehicle may be slow.

According to an embodiment, a display unit may display the same screen as that in FIG. 6. Because driving stability is high, the processor does not provide speed control or perform an extra notification. A current relative speed and the predetermined driving stability region 610 may be displayed. In some cases, a current driving speed, a wind direction, a wind speed, and driving stability information of the vehicle may be further displayed.

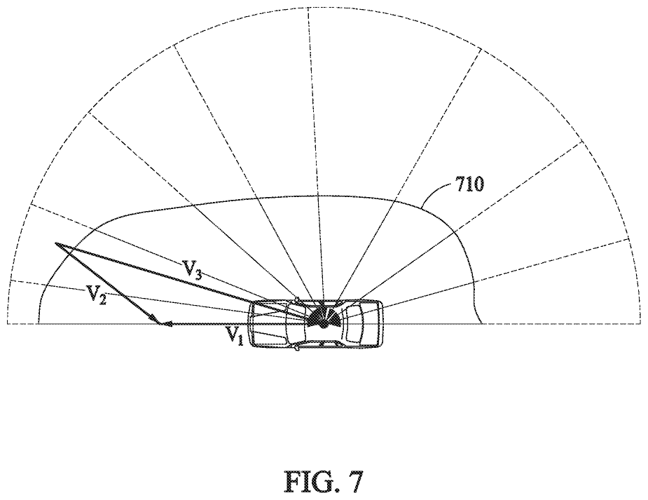

FIG. 7 illustrates a region with low driving stability according to an embodiment.

Because a current relative velocity V₃ gets out of a predetermined driving stability region 710, driving stability may be low. In other words, it is unstable.

There may be strong wind from the outside of the vehicle or a driving speed of the vehicle may be very fast.

According to an embodiment, a display unit may display the same screen as that in FIG. 7. A current relative speed may be displayed in red or may be displayed to be blinking, by a notification unit. Alternatively, when the current relative velocity V3 increases excessively, a controller may limit acceleration of the vehicle or may control the vehicle to decelerate.

According to another embodiment, each wheel of the vehicle may be independently controlled as well as performing deceleration control to enhance driving stability. In detail, driving force delivered to each wheel may be suitably distributed in response to a driving stability region to enhance driving stability. For example, when a strong wind blows in a right front direction of the vehicle, large driving force may be distributed to a right wheel and small driving force may be distributed to a left wheel to perform individual control.

According to another embodiment, it is possible to perform steering control of a steering wheel depending on determining driving stability. In other words, a direction of each wheel may be controlled in response to determining driving stability. Similar to the example described above, when a strong wind blows in a right front direction of the vehicle, each wheel (or a steering wheel) may be minutely turned in the right direction to enhance driving stability of the vehicle.

As described above, the driving stability region 710 may be a region which is set through wind tunnel tests and a region connecting points indicating whether it is stable to any relative speed in response to various conditions of the vehicle.

As shown in FIGS. 6 and 7, the relative velocity V₃ acting on the vehicle is a value obtained by subtracting a driving velocity V₁ of the vehicle from a velocity V₂ of the wind. All the velocities are vectors. The relative wind may be measured by a wind sensor and may be corrected and obtained by a correction formula.

As shown in FIG. 7, when the current relative velocity V₃ gets out of the predetermined driving stability region 710, it may be determined that it is unstable. As shown in FIG. 6, when the current relative velocity V₃ is within the driving stability region 610, it may be determined that it is stable. Because the relative velocity V₃ shown in FIG. 7 gets out of the driving stability region 710, it may be considered that it is unstable.

The driving stability region 710 may be varied adaptively according to situations. A default driving stability region may be set through wind tunnel tests and may be varied adaptively according to a state of the vehicle, a weather state around the vehicle, or the like.

Illustratively, but not by way of limitation, information may be collected by an illumination sensor, a rain sensor, or the like generally included in the vehicle, and a driving stability region may be varied according to the information. In detail, when it is determined that the intensity of illumination is low due to a tunnel or night by the illumination sensor, the driving stability region may be narrowly set. Alternatively, when it is determined that it rained a lot by the rain sensor, the driving stability region may be set to be narrower than a default setting.

According to another embodiment, the driving stability region may be set differently according to a degree of tire wear, the age of the vehicle, a total driving distance of the vehicle, or the like among states of the vehicle. A driving distance of the vehicle may be generally accumulated from the factory release and information about the accumulated driving distance may be received. When the vehicle travels over a predetermined distance, the driving stability region may be set to be narrower than that the factory default.

Alternatively, when it is determined that the degree of the tire wear is large, a method for setting the driving stability region to be narrow is possible.

According to another embodiment, a method for subdividing and determining the driving stability region into an immediate risk region, an attention region, a stable region, and the like is possible. For example, the outside of the default driving stability region may be classified as an attention region or an immediate risk region.

The foregoing devices may be realized by hardware elements, software elements and/or combinations thereof. For example, the devices and components illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described exemplary embodiments of the inventive concept may be implemented with program instructions which may be executed through various computer means and may be recorded in computer-readable media. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to act as one or more software modules to perform the operations of the above-described exemplary embodiments of the inventive concept, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A driving assistance apparatus for a vehicle, the apparatus comprising:
a wind sensor configured to be attached to one side of the vehicle and measure a wind direction and a wind speed; and
a processor configured to compare a relative speed of the vehicle with respect to the wind with a predetermined driving stability region using a driving speed of the vehicle and information about the wind direction and the wind speed, which are measured by the wind sensor, to determine driving stability.

2. The apparatus of claim 1, further comprising:
a display unit configured to display the driving stability region and the driving stability.

3. The apparatus of claim 1, further comprising:
a notification unit configured to provide a notification of a warning message when the relative speed of the vehicle gets out of the predetermined driving stability region.

4. The apparatus of claim 1, wherein the wind sensor is attached to a bonnet or a roof of the vehicle.

5. The apparatus of claim 1, further comprising:
a controller configured to decelerate the vehicle or separately control a direction and a rotational speed of each wheel when the relative speed of the vehicle gets out of the predetermined driving stability region.

6. The apparatus of claim 1, wherein the wind sensor is any one of a multi-hole pressure probe, an ultrasonic wind anemometer, a laser Doppler velocimetry (LDV), a particle image velocimetry (PIV), or a how-wire anemometer.

7. A driving assistance method for a vehicle, which is at least temporarily implemented by a computer, the method comprising:
measuring, by a wind sensor attached to one side of the vehicle, a two-dimensional wind direction and wind speed;
calculating, by a processor, a relative speed of the vehicle with respect to the wind using a driving speed of the vehicle and information about the wind direction and wind speed measured by the wind sensor; and
comparing the relative speed of the vehicle with respect to the wind with a predetermined driving stability region to determine driving stability.

8. The method of claim 7, further comprising:
displaying, by a display unit, the driving stability region and the driving stability.

9. The method of claim 7, further comprising:
providing, by a notification unit, a notification of a warning message, when the relative speed of the vehicle gets out of the predetermined driving stability region.

10. The method of claim 7, wherein the wind sensor is attached to a bonnet or a roof of the vehicle to measure the two-dimensional wind direction and wind speed.

11. The method of claim 7, further comprising:
decelerating, by a controller, the vehicle or separately controlling, by the controller, a direction and a rotational speed of each wheel, when the relative speed of the vehicle gets out of the predetermined driving stability region.

12. The method of claim 7, wherein the wind sensor is any one of a multi-hole pressure probe, an ultrasonic wind anemometer, a laser Doppler velocimetry (LDV), a particle image velocimetry (PIV), or a how-wire anemometer.

13. A computer-readable storage medium storing a program for performing the driving assistance method of claim 7.

14. A vehicle including a driving assistance apparatus for the vehicle, the vehicle comprising:
a wind sensor configured to be attached to one side of the vehicle and measure a wind direction and a wind speed; and
a processor configured to compare a relative speed with respect to the wind of the vehicle with a predetermined driving stability region using a driving speed of the vehicle and information about the wind direction and the wind speed, which are measured by the wind sensor, to determine driving stability.

15. A computer-readable storage medium storing a program for performing the driving assistance method of claim 8.

16. A computer-readable storage medium storing a program for performing the driving assistance method of claim 9.

17. A computer-readable storage medium storing a program for performing the driving assistance method of claim 10.

18. A computer-readable storage medium storing a program for performing the driving assistance method of claim 11.

19. A computer-readable storage medium storing a program for performing the driving assistance method of claim 12.
